(19) United States
(12) Patent Application Publication
(10) Pub. No.: US 2002/0039246 A1
(43) Pub. Date: Apr. 4, 2002

(54) Variable TPI data recording in hard disc drives

(76) Inventors: Mingzhong Ding, Singapore (SG); WingKong Chiang, Singapore (SG); KianKeong Ooi, Singapore (SG); Kevin A. Gomez, Singapore (SG); BengWee Quak, Singapore (SG); KweeTeck Say, Singapore (SG)

Correspondence Address: Westman Champlin & Kelly, 900 Second Avenue South, Suite 1600 - International Centre, Minneapolis, MN, 55402-3319, US

(21) Appl. No.: 09/885,302

(22) Filed: Jun. 20, 2001

Related U.S. Application Data
(60) Provisional application No. 60/225,254, filed on Aug. 15, 2000.

(51) Int. Cl. G11B 21/02; G11B 5/09

(52) U.S. Cl. 360/75; 360/48

(57) ABSTRACT

A data storage device has optimized track densities for each of a plurality of data storage surfaces. Each storage surface of the data storage device has a plurality of adjacent data storage tracks positioned at a track density defined by the width of the confronting head. Head/surface combinations are arranged so that the average of the track densities of all of the surfaces equals a selected nominal track density for the data storage device. A ratio between the track density and the servo band density is stored for each data storage surface. During operation of the storage device, the track density and other parameters necessary to the operation of the device are re-calculated from the ratio and established device parameters.

### CROSS-REFERENCE TO RELATED APPLICATION

This application claims benefit of Provisional Application No. 60/225,254 filed Aug. 15, 2000 by Mingzhong Ding, WingKong Chiang, KianKeong Ooi, Kevin Arthur Gomez, BengWee Quak and KweeTeck Say for “Variable TPI Data Recording in Hard Disk Drives”.

### FIELD OF THE INVENTION

This invention relates to optimizing track density in data storage devices and particularly to optimizing the track density for each recording surface of a multi-surface hard disc drive.

### BACKGROUND OF THE INVENTION

Areal data density represents the quantity of data (e.g., number of bits) that may be recorded in a given area of a recording surface. In a disc drive, areal density is the product of the track density, which is the number of tracks per inch (TPI) across the radius of the disc surface, and bit density, which is the number of bits per inch (BPI) recorded along a track. The TPI is selected during the design of the disc drive; the track width is based on the selected TPI. As the TPI increases, the track width decreases.

In the past, the TPI was the same for all surfaces of the disc drive. The magnetic heads were manufactured to specifications based on the track width, and hence the TPI. Typically, the width of the write head was about 80% of track pitch and the width of the read head was about 40-50% of track pitch. As the track pitch became more dense, the recording heads became correspondingly smaller, and existing manufacturing tolerances produced larger variations between the widths of the read and write transducing portions of the head. Consequently, the worst-case head width had to meet the minimal requirements for maximum width and minimal track density specified for the drive. As a result, a greater percentage of heads were “out of spec”, meaning they did not meet the minimal requirements for the disc drive, thereby raising the costs for head. Moreover, the heads that exceeded the specifications were not used to their full capability. The present invention provides a solution to this and other problems, and offers other advantages over the prior art.

### SUMMARY OF THE INVENTION

The track density of each recording surface of a data storage device, such as a disc drive or the like, is optimized. In a first embodiment, adjacent data storage tracks on a surface of a movable storage media of a data storage device are arranged at a pitch defined by the width of the confronting head. Preferably, servo sectors on all of the storage media surfaces are arranged at a pitch at least as large as the largest pitch of the data storage tracks.

A second embodiment is directed to a process of optimizing data storage track density on each of N storage surfaces of a data storage apparatus. In one form, a nominal track density, TPIₙₒₘ, is defined for the data storage apparatus, and a servo band density, SBPI, is defined as greater than TPIₙₒₘ. N heads of known width are associated with respective storage surfaces to form respective head/surface combinations i, each having a track density DTPIᵢ defined by the width of the head of the respective combination. The sum of all track densities,

$${\sum }_{i = 0}^{N - 1} {DTPI}_{i} ,$$

DTPIᵢ, is based on the nominal track density, TPIₙₒₘ, and the number N of heads. A value βi is calculated for each combination i based on the respective track density, DTPIᵢ, and the servo band density, SBPI, and the calculated values are stored.

In another form, the value of βi is calculated by defining a nominal bit density, BPIₙₒₘ, for the data storage apparatus and identifying a maximal bit density, BPII, for each head/surface combination i. The value of βi is calculated for each combination based on the respective maximal data density. The data track density, DTPIᵢ, may be calculated based on the value of βi. Preferably, each value of βi is stored at a selected track on the respective storage surface.

In another embodiment, the data storage device is operated by retrieving the value of βi for at least one storage surface, and computing the data track density DTPIᵢ for the at least one storage surface based on the retrieved value βi and the servo band density SBPI.

These and other features and benefits that characterize the present invention will be apparent upon reading the following detailed description and review of the associated drawings.

### BRIEF DESCRIPTION OF THE DRAWINGS

FIG. 1 is a perspective view of a disc drive in which aspects of the present invention may be practiced.

FIG. 2 is a flow diagram of the process of optimizing track density in a multisurface disc drive.

FIG. 3 illustrates the relationship between data track density and servo burst density according to the present invention.

FIG. 4 is a flow diagram of a second embodiment of the process of optimizing track density in a multisurface disc drive.

FIGS. 5-9 are graphs illustrating operation of a disc drive having optimized track densities in accordance with the present invention.

### DETAILED DESCRIPTION OF ILLUSTRATIVE EMBODIMENTS

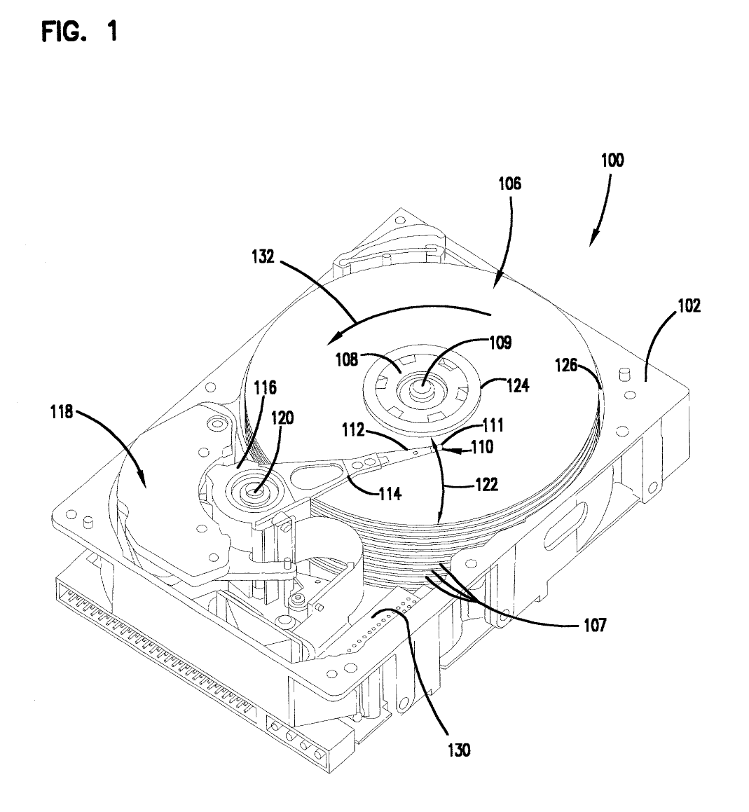

FIG. 1 is a perspective view of a disc drive 100 in which the present invention is useful. Disc drive 100 includes a housing with a base 102 and a top cover (not shown). Disc drive 100 further includes a disc pack 106, which is mounted on a spindle motor (not shown), by a disc clamp 108. Disc pack 106 includes a plurality of individual discs 107, which are mounted for co-rotation about central axis 109. Each disc surface has an associated disc head-slider 110 that is mounted to disc drive 100 for communication with the confronting disc surface. Head-slider 110 includes a slider structure arranged to fly above the associated disc surface of an individual disc of disc pack 106, and a transducing head 111 arranged to write data to, and read data from, concentric tracks on the confronting disc surface. The concentric tracks are, in effect, parallel to each other at different radii on the disc. In the example shown in FIG. 1, head-sliders 110 are supported by suspensions 112 which are in turn attached to track accessing arms 114 of an actuator 116. Actuator 116 is driven by a voice coil motor (VCM) 118 to rotate the actuator, and its attached heads 110, about a pivot shaft 120. Rotation of actuator 116 moves the heads along an arcuate path 122 to position the heads over a desired data track between a disc inner diameter 124 and a disc outer diameter 126. Voice coil motor 118 is driven by servo electronics included on circuit board 130 based on signals generated by the heads of head-sliders 110 and a host computer (not shown). Read and write electronics are also included on circuit board 130 to supply signals to the host computer based on data read from disc pack 106 by the read heads of head-sliders 110, and to supply write signals to the write head of head-sliders 110 to write data to the discs.

Data are written in the form of data bits along the length of the concentric tracks on each surface of discs 107; the number of bits written to a track in a given unit length of the track is known as bit density. Bit density is usually expressed in the number of bits per inch (BPI) along the track. The length L of each track is based on the radius r of the concentric track and can be expressed as L=2 πr. For a given recording frequency, the number of bit positions in each track is the same. However, the BPI is higher at inner tracks than at outer tracks due to the different track lengths. It is common to employ a recording scheme known as zone bit recording to record tracks in different radial zones at different frequencies so that the BPI is maximized for each zone. Nevertheless, bit densities (BPI) are higher at inner tracks of the zone than at outer tracks.

The track density (TPI) is established in the design phase of the disc drive and the recording heads 111 are manufactured to specifications based on the TPI. As the TPI becomes greater (less radial pitch between tracks), the recording heads must be more narrow. However, for given manufacturing tolerances, fewer heads meet the more narrow width requirements for higher numbers of tracks per inch. Consequently, the acceptance rate for manufactured heads drops, adding to the cost of heads. Some heads that exceed the design are not used to their full capability. The present invention optimizes the track density for a given head/surface combination and allows use of different track densities for different head/surface combinations in a given multi-surface disc drive. Optionally, the invention also uses an optimal BPIᵢ that is separately established for each disc surface such that the disc exhibits a design or nominal BPI, BPIₙₒₘ, based on the sum of the individual head/surface BPIs:

$${BPI}_{non} = \frac{{\sum }_{i = 0}^{N - 1} {BPI}_{i}}{N} ,$$

where N is the number of head/surface combinations.

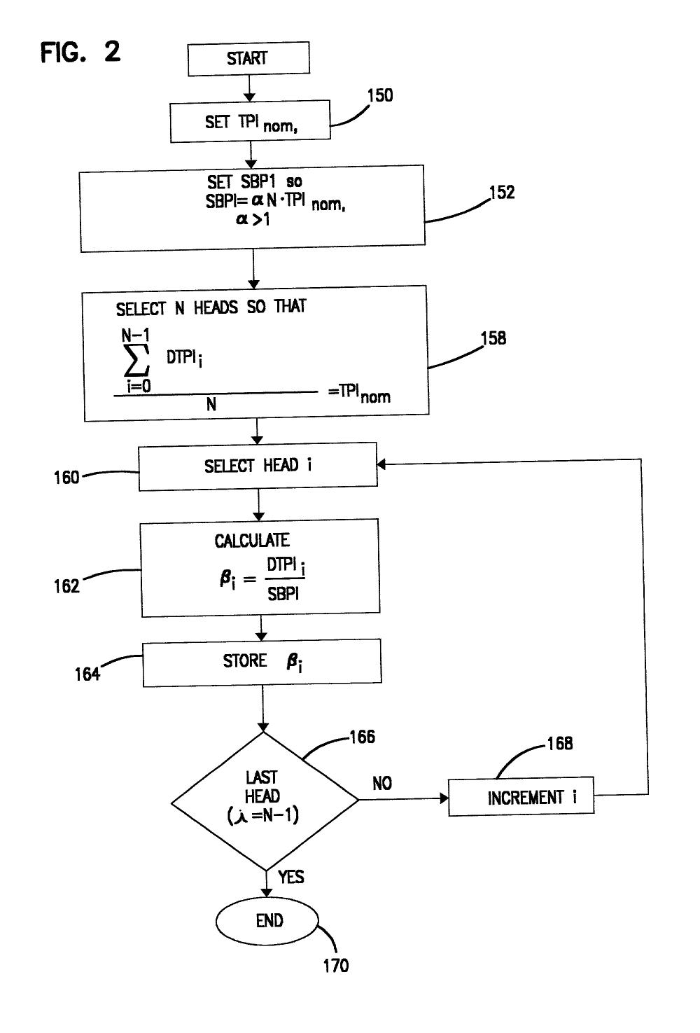

FIG. 2 is a flow diagram illustrating the steps of one embodiment of the process of optimizing the TPI of a disc drive. The process commences at step 150 by establishing TPIₙₒₘ, which is the nominal or design TPI for the disc drive. At step 152 the servo band density, in servo bands per inch (SBPI), is established for all of the disc surfaces of the disc drive based on the nominal TPI:

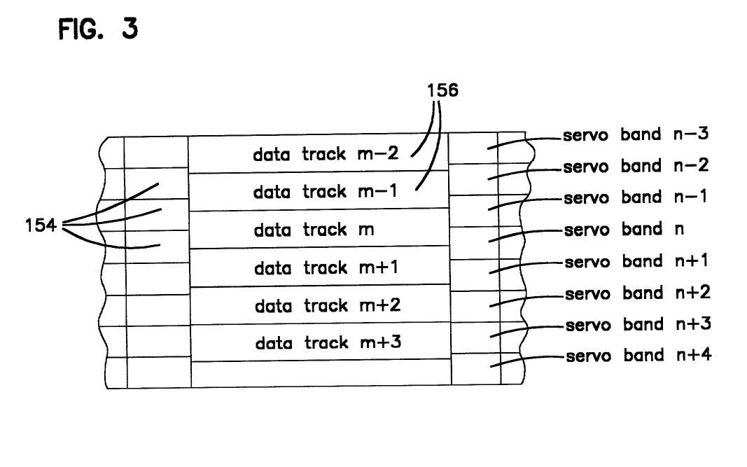

SBPI=α·TPIₙₒₘ, (1)

where α>1. Thus, as shown in FIG. 3, the servo bands 154 are more narrow than the data tracks 156, so SBPI is larger than TPIₙₒₘ. Conveniently, the servo bands 154 can be written at this step in the process. For the purposes of servo control, SBPI is the same for all head/surface combinations of the disc drive.

At step 158, the recording heads for the disc drive are selected and their widths are identified. More particularly, the heads are selected based on their widths so that the average of the track densities produced by these heads, measured in data tracks per inch (DTPI), equals the design TPIₙₒₘ. The head width may be measured by a microscope, or more favorably, by recording test tracks with the head and reading those tracks to determine measured levels of write and read thresholds off of track center. More particularly, the width of the head may be identified from the off-track capability of the head, which in turn is identified from read error rates at off-track positions in a manner well known in the art. The data tracks per inch DTPIᵢ for each head is thus identified by inspection of the track width or by testing. Thus at step 158, N heads are selected so that the average data track density equals the nominal data track density:

$$\frac{{\sum }_{i = 0}^{N - 1} {DTPI}_{i}}{N} = {TPI}_{nom} , \qquad ( 2 )$$

where DTPIᵢ is the number of data tracks per inch for each head/surface combination i, i is the number of the head/surface combination under consideration, TPIₙₒₘ is the nominal or design tracks per inch for the disc drive and N is the number of head/surface combinations in the disc drive.

At step 160, one of the heads i is selected for test. As indicated at step 158, head i has a width producing a known DPTIᵢ. At step 162, a ratio β is calculated for head i of the disc drive, representing the ratio of DPTIᵢ of the head to the SBPI of the disc drive. More particularly, βi is calculated for each surface i as

$${β}_{i} = \frac{{DTPI}_{i}}{SBPI} . \qquad ( 3 )$$

Moreover, a relationship between α and β can be expressed from Equations 1-3 as:

$$\frac{1}{N} {\sum }_{i = 0}^{N - 1} {β}_{i} = \frac{1}{α} \qquad ( 4 )$$

Thus, an optimal value for βi is derived at step 162, and the result is stored at step 164 in one of the reserved cylinders or data tracks on the surface that are used to store drive-dependant data. The reserved tracks are ordinarily at the innermost or outermost locations on the storage surface. It is preferred that the track width of the reserved cylinders be identical for all surfaces of the disc drive so that the reserved cylinders are in the same position on all disc surfaces. Consequently, drive-dependent data in the reserve tracks may be retrieved during normal operation mode of the disc drive without knowledge of the value of β.

The process performed at steps 162-164 is repeated for each head i in the disc drive until, at step 166, βi has been calculated and stored for the last head (N−2) in the disc drive. More particularly, if a determination is made at step 166 that βi has not been determined for the last head, the value of i is incremented at step 168 and the process loops back to step 160 to select the next head. The process continues until βi has been optimized and stored for all head/surface combinations. At that time the process ends at step 170.

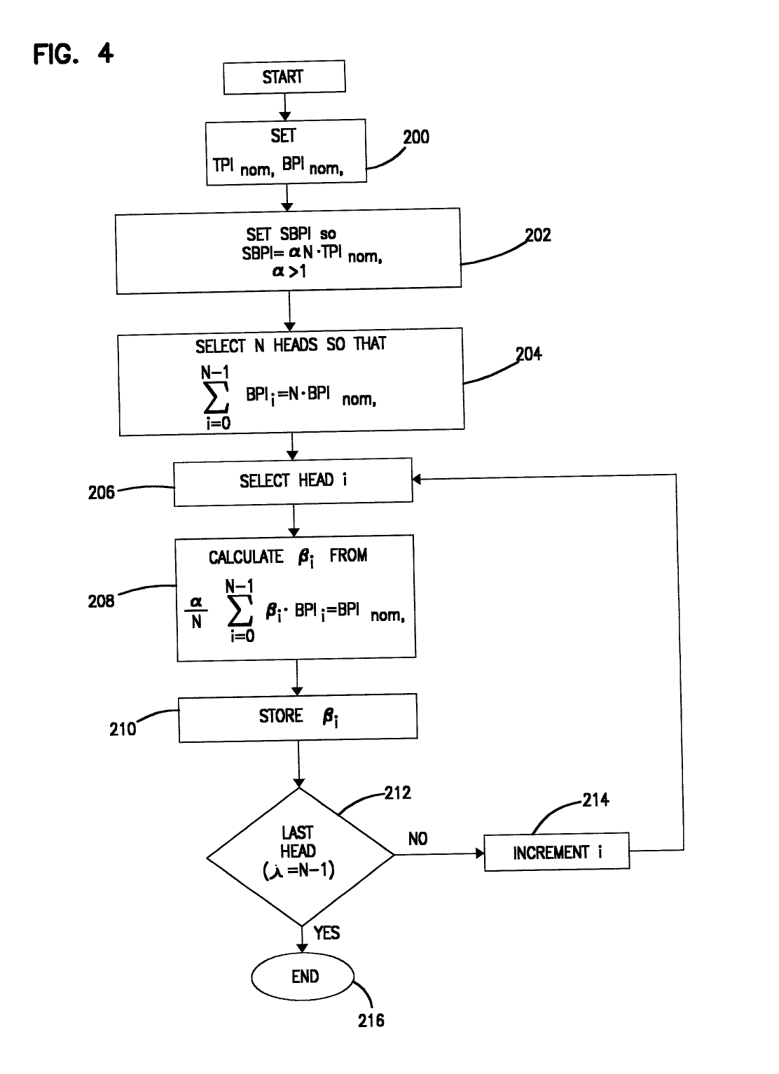

FIG. 4 is a flow diagram illustrating the steps of another embodiment of the process of optimizing the TPI of a disc drive. In the process illustrated in FIG. 4, a value of βi is calculated based on BPIₙₒₘ. The process is similar to that described in FIG. 2, except that at step 200, the value of BPIₙₒₘ is established (in addition to establishing TPIₙₒₘ as at step 150). At step 204, the selection of heads is based on the bit recording density along the length of the track as

$$\frac{{\sum }_{i = 0}^{N - 1} {BPI}_{i}}{N} = {BPI}_{nom} .$$

Steps 202 and 206 are the same as steps 152 and 160 described in connection with FIG. 2. At step 208, the value of βi is calculated. As described above, an optimal value of BPIᵢ is established for each disc surface such that an average of the bit densities equals the nominal bit density BPIₙₒₘ:

$$\frac{{\sum }_{i = 0}^{N - 1} {BPI}_{i}}{N} = {BPI}_{nom} .$$

For a given nominal areal density, which is the product of the nominal track density and nominal bit density, TPIₙₒₘ·BPIₙₒₘ, the value of βi for each surface can be determined from the following relationship:

$$\frac{α}{N} {\sum }_{i = 0}^{N - 1} ( {β}_{i} \cdot {BPI}_{i} ) = {BPI}_{nom} . \qquad ( 5 )$$

The value of βi is optimized during the drive level certification tests and is stored at step 210 in one of the reserved cylinders or data tracks on the surface that are used to store drive-dependant data, as described in connection with step 164 in FIG. 2. The process loops back through steps 212 and 214 to step 206 in the same manner as described in connection with steps 166 and 168 in FIG. 2. Data in the reserved tracks are retrieved during normal operation mode.

The process of FIG. 4 is particularly advantageous where a single disc is employed and a selection of data track densities is not available for the disc drive. Nevertheless, while it is advantageous for single disc drives, the process of FIG. 4 may be employed in multiple disc drives as well.

In the operation of disc drive 100, the value of βi is retrieved from the reserve track on a surface of a disc 107. The track density for the respective disc surface is calculated from the recovered value of βi and the servo band density established for the disc drive as DTPIᵢ=βᵢ·SBPI. Parameters related to the individual head are recalculated by the drive processor. More particularly, drive parameters are stored in the controller electronics on circuit board 130 or are recovered from selected reserve tracks on a surface of a disc 107 of the disc drive. These drive parameters include the number (n) of servo bands on each disc, the nominal write fault position threshold (X_Thresholdₙₒₘ) and the nominal write fault and velocity threshold (X_V_Thresholdₙₒₘ) established for the disc drive. The maximum number of data tracks or cylinders (MaxCylᵢ), the write fault position threshold (X_Thresholdᵢ) and the write fault and velocity threshold (X_V_Thresholdᵢ) are recalculated for each disc surface i, based on these drive parameters and the servo band density (SBPI), as follows:

$${MaxCyl}_{i} = n \cdot \frac{1}{{β}_{i}} , {X\_Threshold}_{i} = \frac{1}{{β}_{i}} \cdot {X\_Threshold}_{nom} , and$$

$$X\_V {\_Threshold}_{i} = \frac{1}{{β}_{i}} \cdot X\_V {\_Threshold}_{nom} .$$

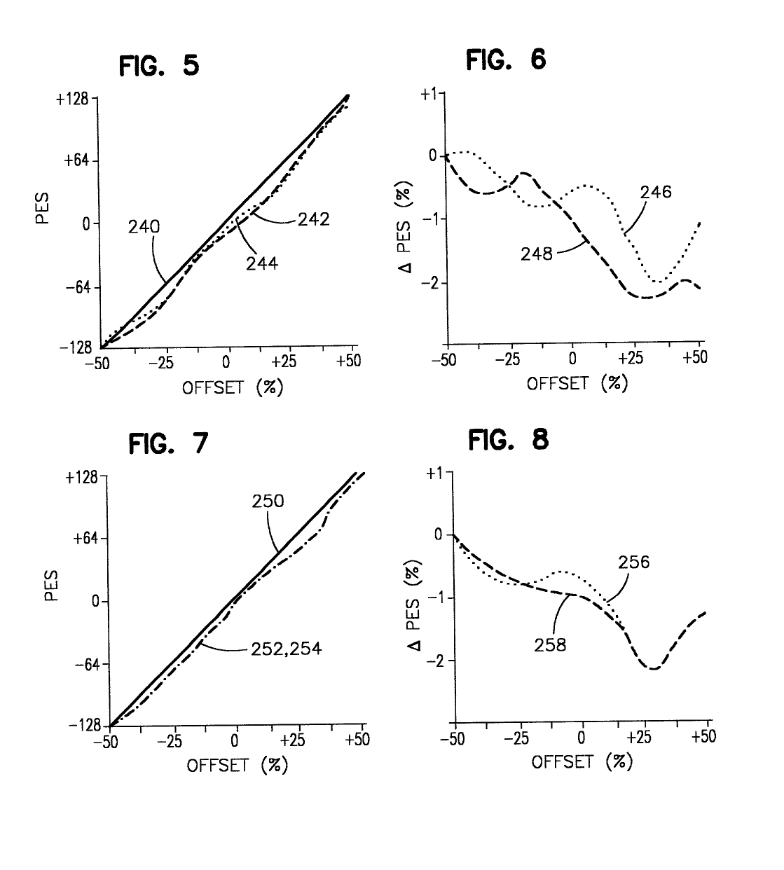

FIGS. 5-9 are graphs illustrating the performance of a multisurface disc drive according to the present invention. FIG. 5 illustrates the normalized position error signal (PES) based on off-track position at high and low temperatures. The physical offset from track center is illustrated ranging between −50% and +50%, that is midway between adjacent tracks in one direction and midway between adjacent tracks in the other direction from track center. The ideal position error signal is illustrated at 240 and is a linear change from highly negative at −50% offset from track center to highly positive at +50% offset. The actual position error signals for high and low temperatures are illustrated at 242 (dashed line) and 244 (dotted line), respectively. FIG. 6 illustrates the percentage of the difference of the position error signals for high and low temperatures from the ideal position error signal. More particularly, graph 246 illustrates the percentage of deviation of the position error signal from the ideal position error signal during low temperature operation, whereas graph 248 illustrates the percentage of deviation of the position error signal from the ideal position error signal during high temperature operation. FIG. 6 thus illustrates that a deviation of no more than about 2% in the position error signal occurs at either high or low temperatures. Since deviation of the actual position error signal is the result of numerous factors, including temperature, pressure, track density, recording strength, etc., a 2% deviation in the position error signal is considered acceptable. Indeed, deviation of the position error signal between the high and low temperatures, namely the difference between graphs 246 and 248 in FIG. 6 can be viewed as being less than about 0.5%.

FIGS. 7 and 8 are similar to FIGS. 5 and 6 and illustrate the effects of pressure (due to high and low altitude) on the disc drive. Thus, FIG. 7 illustrates deviation from the ideal the position error signal 250 of the actual position error signals 252 and 254 at low pressure (at 10,000 feet) and at high pressure (at 5,000 feet), respectively. The differences of the actual position error signals from the ideal position error signal due to low and high pressures are illustrated in FIG. 8 at 256 and 258, respectively. Like the condition illustrated in FIGS. 5 and 6, the conditions illustrated in FIGS. 7 and 8 illustrate position error signal deviations due to all causes. The difference between graphs 256 and 258 illustrate the difference due to pressure changes is less than 0.5%.

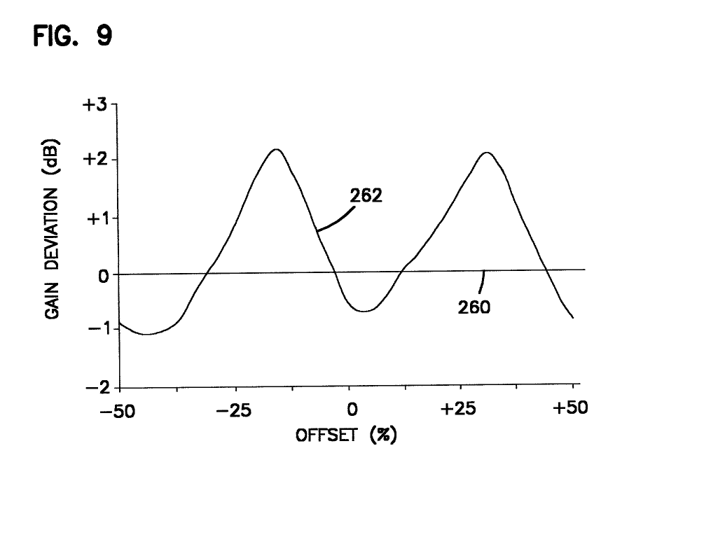

FIG. 9 illustrates the deviation of gain based on offset between −50% and +50% of track center. The ideal gain deviation would be constant over the range between −50% and +50% of track center, as indicated by a deviation of 0 dB by graph 260. The actual deviation follows curve 262, and varies between about +2 and −1 dB. Thus, the gain varies from a linear gain by about 3 dB over the range between −50% and +50% of track center. The graph of FIG. 9 can be used to define a gain compensation to linearize the gain over the entire offset range.

Stated alternatively, a data storage device 100 includes a plurality of heads 111 each having a width. A plurality of moveable storage surfaces on discs 107 are arranged so that each storage surface is confronted by at least one head and each storage surface has a plurality of adjacent data storage tracks. The data storage tracks are positioned on the respective storage surface at a track density defined by the width of the confronting head to optimize the data storage track density.

In preferred embodiments, each storage surface also includes a plurality of servo bands arranged at a servo band density having a pitch at least as large as the largest pitch of the data storage tracks on all of the storage surfaces.

The data storage track densities are optimized for each of the N storage surfaces 107 of a data storage apparatus 100. A nominal track density, TPIₙₒₘ, is defined for or assigned to the data storage apparatus, and a servo band density, SBPI, is defined at a pitch greater than that of the nominal track density TPIₙₒₘ. N heads 111 are selected each having a known width. Each head is associated with a respective one storage surface to form a head/surface combination. Each head/surface combination has a track density DTPIᵢ defined by the width of the head for the respective combination i. A value βi is calculated for each head/surface combination representative of an arithmetic combination of representations of the respective track density and the servo band density. The calculated value of βi is stored.

In one embodiment, the value βi is based on the respective track density DTPIᵢ and the servo track density, SBPI. In another embodiment, a nominal, or design, data density BPIₙₒₘ is defined for or assigned to the data storage apparatus, and each head/surface combination has a maximal data density, BPIᵢ. The values of βi are based on the respective maximal data density, nominal data density.

In another embodiment, the data storage device is operated by retrieving the value of βi for at least one storage surface, and computing the data track density DTPII for the at least one storage surface based on the retrieved value βi and the servo band density SBPI.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the variable track density technique while maintaining substantially the same functionality without departing from the scope and spirit of the present invention. In addition, although the preferred embodiment described herein is directed to a technique for optimizing track density for an embedded servo disc drive system, it will be appreciated by those skilled in the art that the teachings of the present invention can be applied to other systems, such as dedicated servo disc drive systems employing servo information on a dedicated servo surface, to optical disc drive systems and to systems whose servo controls do not rely on information recorded on the movable storage medium, such as tape drive systems, without departing from the scope and spirit of the present invention.

What is claimed is:

1. A data storage device including:
a plurality of head/surface combinations each including a moveable storage surface containing adjacent data storage tracks and a head arranged to transfer information with the data storage tracks, the head having a width defining a maximum track density between adjacent data storage tracks; and
means optimizing the data storage track density of each storage surface.

2. The data storage device of claim 1, wherein the plurality of head/surface combinations comprises:
a plurality of heads each having a respective width, and a plurality of moveable storage surfaces having a plurality of adjacent data storage tracks and arranged so that at least one head confronts each storage surface, and
the means optimizing the data storage track density comprises:
an arrangement of the data storage tracks at a pitch defined by the width of the confronting head.

3. The data storage device of claim 2, wherein the storage surfaces further include a plurality of servo sectors arranged at a pitch at least as large as the largest pitch of the data storage tracks on all of the storage surfaces.

4. The data storage device of claim 2, wherein the data storage device is a disc drive and the data storage tracks are concentric on the respective storage surface such that the data storage tracks are radially positioned on the respective storage surface at the pitch.

5. The disc drive of claim 4, wherein the storage surfaces further include a plurality of servo sectors arranged at a pitch at least as large as the largest pitch of the data storage tracks on all of the storage surfaces.

6. A process of optimizing densities of data storage tracks on each of N storage surfaces of a data storage apparatus, where N is an integer, the process comprising steps of:
a) defining a nominal track density for the data storage apparatus;
b) selecting at least N heads each having a known width;
c) defining a servo band density at a pitch that is at least as great as a pitch of the nominal track density;
d) associating each head with a respective one storage surface to form a head/surface combination having a track density on the storage surface defined by the width of the head of the respective combination;
e) for each head/surface combination, calculating an arithmetic combination of a representation of the respective track density and a representation of the servo band density; and
f) storing each of the calculated arithmetic combinations.

7. The process of claim 6, wherein each arithmetic combination is a ratio of a representation of the respective track density and a representation of the servo band density.

8. The process of claim 6, wherein step (f) is performed by storing the respective arithmetic combination to a selected track on the respective storage surface.

9. The process of claim 6, wherein step (e) is performed based on the servo band density and the respective track density.

10. The process of claim 6, wherein step (e) is performed by calculating an arithmetic combination for each head/surface combination as
$${β}_{i} = \frac{{DTPI}_{i}}{SBPI} ,$$
where DTPIᵢ is the track density of the respective storage surface and SBPI is the servo band density.

11. The process of claim 6, wherein the average track density of the storage surfaces for the respective heads selected at step (d) is at least as great as the nominal track density.

12. The process of claim 6, wherein N>1.

13. The process of claim 6, further including
g) calculating recording parameters of a data storage surface during operation of the data storage apparatus based on the value of the respective arithmetic combination and nominal recording parameters.

14. The process of claim 6, wherein the head associated with a respective storage surface at step (d) defines a maximal data density for the respective storage surface, and the process further including the step:
g) defining a nominal data density for the data storage apparatus, and
and step (e) is performed based on representations of the nominal data density, the nominal track density, the maximal data density for the respective surface and the servo band density.

15. The process of claim 14, wherein the servo band density is calculated during step (c) as SBPI=α·TPIₙₒₘ, where α>1 and TPIₙₒₘ is the nominal track density.

16. The process of claim 15, wherein step (e) is performed by calculating the arithmetic combination for each head/surface combination based on
$$\frac{α}{N} {\sum }_{i = 0}^{N - 1} ( {β}_{i} \cdot {BPI}_{i} ) = {BPI}_{nom} ,$$
where βi is the respective arithmetic combination, BPIᵢ is the respective maximal data density and BPIₙₒₘ is the nominal data density.

17. The process of claim 13, wherein step (f) is performed by storing each value of βi to a selected track on the respective storage surface.

18. A process of operating a data storage device having a plurality of data storage surfaces and respective confronting heads arranged to transfer data between the respective head and data tracks on the respective storage surface, the data tracks on each storage surface being arranged substantially parallel to each other at a respective data track density, each storage surface having servo bands substantially parallel to each other at a servo band density that is substantially the same for each of the plurality of storage surfaces, the storage device further storing a respective value representing a relationship between the data track density for the respective storage surface and the servo band density, the process comprising steps of:
a) retrieving the value for at least one storage surface, and
b) computing the data track density for the at least one storage surface based on the retrieved value and the servo band density.

19. The process of claim 18, further including the step of:
c) computing additional parameters associated with the at least one storage surface based on nominal storage device parameters and the retrieved value.

20. The process of claim 19, wherein the additional parameters are selected from the group consisting of a maximum number of data tracks on the at least one storage surface, a write fault position threshold, and a write fault and velocity threshold.
